(19) United States
(12) Patent Application Publication
(10) Pub. No.: US 2004/0127347 A1
(43) Pub. Date: Jul. 1, 2004

(54) Method for manufacturing fuel cell electrode

(75) Inventors: Seol-ah Lee, Kyungki-do (KR); Chan-ho Pak, Seoul (KR)

Correspondence Address: BURNS DOANE SWECKER & MATHIS L L P, POST OFFICE BOX 1404, ALEXANDRIA, VA, 22313-1404, US

(73) Assignee: Samsung SDI Co., Ltd., Kyungki-do (KR)

(21) Appl. No.: 10/460,194

(22) Filed: Jun. 13, 2003

(30) Foreign Application Priority Data
Dec. 30, 2002 (KR) 2002-87156

(51) Int. Cl. H01M 4/88; B05D 5/12

(52) U.S. Cl. 502/101; 427/115

(57) ABSTRACT

Provided is a simplified method for manufacturing an electrode for fuel cells, in which a separate process for forming a catalyst layer is not needed. The method involves applying a slurry containing a catalytic metal precursor, a catalyst carrier with micropores, an ionomer with cation exchange groups, and a solvent to a gas diffusion layer to form an unreduced catalyst layer, and thermally treating the unreduced catalyst layer in a reduction atmosphere to reduce the catalytic metal precursor to form a catalytic layer having catalytic metal particles embedded in the micropores of the catalyst carrier. Since the catalyst layer is formed during the formation of the electrode, the electrode comprising the catalyst layer can be conveniently manufactured within a short time, without the need to separately form the catalyst layer. The simplified method takes a short time and is also advantageous in terms of manufacturing equipment requirements and costs. An electrode fuel cell with good electrochemical activity and improved catalytic efficiency can be manufactured with the method.

### BACKGROUND OF THE INVENTION

This application claims priority from Korean Patent Application No. 2002-87156, filed on Dec. 30, 2002, in the Korean Intellectual Property Office, the disclosure of which is incorporated herein in its entirety by reference.

1. Field of the Invention

The present invention relates to a fuel cell, and more particularly, to an electrode for a fuel cell with a polymer electrolyte membrane.

2. Description of the Related Art

Fuel cells are known as power generators that produce electrical energy through electrochemical reactions of fuel with oxygen. Since they are not based on the Carnot cycle applied to the thermal power generation, their theoretical power generation efficiency is very high. Fuel cells can be used as power sources for small electrical/electronic devices, including portable devices, as well as for industrial, domestic, and transportation applications.

Fuel cells known so far can be classified into polymer electrolyte membrane (PEM) cells, phosphoric acid cells, molten carbonate cells, solid oxide cells, and other kinds depending on the type of electrolyte. The working temperature of fuel cells and component materials therefor are determined depending on the type of electrolyte used in a cell.

In a fuel cell with a polymer electrolyte membrane, gaseous fuel such as hydrogen or a mixture of vaporized methanol and water, or liquid fuel such as aqueous methanol solution is supplied to its anode as fuel. Especially, fuel cells using the mixture of vaporized methanol and water or aqueous methanol solution as fuel to be supplied to the anode are called direct methanol fuel cells.

Throughout the specification of the present invention, the term “fuel cell with a polymer electrolyte membrane” embraces fuel cells with an electrolyte membrane containing polymer, in which the electrolyte membrane may further include an inorganic or organic substance and may have a mono-layered or a multi-layered structure.

Fuel cells with polymer electrolyte membranes are workable at room temperature and are easy to manufacture or miniaturize with high capacitance. Therefore, these fuel cells have various applications, for example, in zero emission vehicles, residential power generation systems, mobile telecommunications equipment, medical equipment, military equipment, equipment in space, and the like.

Typically, a fuel cell with a polymer electrolyte membrane includes an anode where an oxidation reaction of fuel occurs, a cathode where a reduction reaction of oxygen occurs, and an electrolyte membrane interposed between the anode and the cathode to act as a path for migrating hydrogen ions generated at the anode to the cathode.

Each of the anode and cathode includes a gas diffusion layer serving as an entry/exit path of reactants and reaction products and as a current collector, and a catalyst layer containing a catalyst for electrochemically catalyzing the oxidation or reduction reaction.

This catalyst layer includes a catalyst and an ionomer having a proton exchange group. The catalyst may include metallic catalyst particles alone or may have a porous catalyst carrier such as carbon black or a porous catalyst carrier and metallic catalyst particles. The ionomer acts as a binder or as a path for migrating ions.

Examples of methods for manufacturing metallic catalyst particles include an aqueous colloid method suggested by Watanabe et al., Journal of Electroanl. Chem., 229, 395 (1987), and a non-aqueous colloid method suggested by Bonnemann et al., Angew. Chem. Int. Ed, Bngl., 30(10), 1312 (1991).

The method suggested by Watanabe et al. involves producing a metallic composite intermediate through multiple steps, for example, by adding a reducing agent such as Na₂CO₃ or NaHSO₄ into an aqueous solution of platinum chloride hydrate and second metallic chloride, hydrolyzing the intermediate to attain metallic oxide, and producing nano-sized platinum alloy particles through a thermal process of the metallic oxide. In this method, the size of the platinum alloy particles vary greatly depending on the kind of the reducing agent used in each step and the pH level adjusted in each step. In addition, the method necessitates the thermal process.

In the method suggested by Bonnemann et al., the synthesis of a surfactant-stabilized catalyst using a tetrabutylammonium-based reducing agent as a surfactant is followed by a thermal process to separate the surfactant from the catalyst. The resulting metallic catalyst particles have a uniform size of about 2 nm and can be easily dispersed in a carbon carrier. However, this method is complicated and particle size adversely increases slightly through the thermal process.

In another method for manufacturing metallic catalyst particles, various kinds of reducing agents, such as sodium borohydride, sodium formate, sodium thiosulfate, or nitrohydrazine, are added into an aqueous metallic chloride solution to attain nano-sized catalyst particles [N. M. Kagan, Y. N. Pisarev, Y. A. Kaller, V. A. Panchenko, Elektrokhimiya, 9, 1498(1973)].

Conventionally, a catalyst has been manufactured by impregnating a carrier with a metal precursor solution and drying and heating a resultant for reduction. Recently, this conventional method is under active research for application in the synthesis of fuel cell catalysts [M. Gotz, H. Wendt, Electrochim. Acta, 43, 1998, 3637].

U.S. Pat. Nos. 5,211,984 and 5,234,777 disclose methods for manufacturing an electrode for fuel cells, in which a catalyst slurry containing the catalyst obtained using the above or other methods and an ionomer is applied to a gas diffusion layer and dried to form a catalyst layer on the gas diffusion layer.

In these conventional methods for manufacturing electrodes, an electrode is manufactured using the catalyst previously prepared through a separate process, so that the amount of catalyst is doubled; the loss occurs during the preparation of the catalyst and once again during the manufacture of the electrode using the catalyst slurry.

U.S. Pat. Nos. 5,084,144 and 6,080,504 disclose other methods for manufacturing electrodes in which a gas diffusion layer is immersed in a metallic catalyst precursor solution, and a pulsed voltage is applied to incorporate metallic catalyst particles into a carrier. Although fine metallic catalyst particles can be produced with these methods, it is difficult to control the amount of metallic catalyst to be loaded. In addition, the electrode manufactured by these methods is known as having poor electrochemical activity. Therefore, these methods are impractical to use.

Therefore, there still is a need for a simplified method for manufacturing an electrode for fuel cells with high catalytic efficiency.

### SUMMARY OF THE INVENTION

The present invention provides a simplified method for manufacturing an electrode for fuel cells, in which a separate process for forming catalyst is not needed.

In one aspect of the present invention, there is provided a method for manufacturing an electrode for fuel cells, comprising applying a slurry containing a catalytic metal precursor, a catalyst carrier with micropores, an ionomer with cation exchange groups, and a solvent to a gas diffusion layer to form a unreduced catalyst layer, and thermally treating the unreduced catalyst layer in a reduction atmosphere to reduce the catalytic metal precursor to form a catalyst layer having catalytic metal particles embedded in the micropores of the catalyst carrier.

### BRIEF DESCRIPTION OF THE DRAWINGS

The above and other features and advantages of the present invention will become more apparent by describing in detail exemplary embodiments thereof with reference to the attached drawings in which:

FIG. 1 shows the result of an X-ray diffraction analysis performed using electrodes manufactured according to one embodiment of the present invention;

FIG. 2 is a graph comparatively showing performance of a fuel cell according to one embodiment of the present invention and a fuel cell according to Comparative Example 1; and

FIG. 3 is a graph comparatively showing performance of a fuel cell according to another embodiment of the present invention and a fuel cell according to Comparative Example 2.

### DETAILED DESCRIPTION OF THE INVENTION

In a method for manufacturing an electrode for fuel cells according to the present invention, a slurry containing a catalytic metal precursor, a catalyst carrier with micropores, an ionomer with a cation exchange group, and a solvent is applied to a gas diffusion layer to form an unreduced catalyst layer. Next, the unreduced catalyst layer is thermally treated in a reduction atmosphere to reduce the catalytic metal precursor, so that catalytic metal particles reduced from the catalytic metal precursor are incorporated into the micropores of the catalyst carrier.

The catalytic metal particles may be derived from, for example, titanium (Ti), vanadium (V), chromium (Cr), manganese (Mn), iron (Fe), cobalt (Co), nickel (Ni), copper (Cu), zinc (Zn), aluminum (Al), molybdenum (Mo), selenium (Se), tin (Sn), platinum (Pt), ruthenium (Ru), palladium (Pd), tungsten (W), iridium (Ir), osmium (Os), rhodium (Rh), niobium (Nb), tantalum (Ta), lead (Pb), or mixtures of the forgoing metals.

The catalytic metal precursor is in a metallic salt form. Examples of the catalytic metal precursor include chlorides, nitrates, and sulfates of the forgoing catalytic metals and mixtures of the forgoing materials. The catalytic metal precursor may be a mixture of different kinds of catalytic metal precursors. The catalytic metal precursor is preferably a Pt precursor, and more preferably, a mixture of a Pt precursor and a Ru precursor. Examples of a Pt precursor include, but are not limited to, platinum chlorides, platinum nitrates, platinum sulfates, and mixtures of the forgoing materials. Examples of platinum chlorides include, but are not limited to, hydrogen hexachloroplatinate, platinum chloride, sodium hexachloroplatinate, sodium tetrachloroplatinate, potassium tetrachloroplatinate, tetraamineplatinum chloride, tetraamineplatinum tetrachloroplatinate, ammonium hexachloroplatinate, ammonium tetrachloroplatinate, etc., which may be used alone or in combination. Examples of platinum nitrates include, but are not limited to, tetraamine platinum(II) nitrate, tetraamine platinum hydroxide, etc., which may be used alone or in combination.

Examples of a Ru precursor include, but are not limited to, ruthenium chlorides, ruthenium nitrates, ruthenium sulfates, and mixtures of the forgoing materials. Examples of ruthenium chlorides include, but are not limited to, ruthenium chloride, ruthenium nitrosyl chloride hydrate, etc., which may be used alone or in combination.

In the present invention, an electrode with a Pt/Ru catalyst layer can be manufactured using a mixture of the Pt precursor and the Ru precursor. This electrode with the Pt/Ru catalyst layer is suitable for the anode of direct methanol fuel cells. If the amount of either Pt or Ru composing the catalyst layer is too small, an effect obtainable by the metal alloy as a catalyst is trivial. Therefore, it is preferable that the Pt precursor and the Ru precursor are mixed in a ratio such that the atomic mole ratio of the metal components, Pt and Ru is 10:90-90:10.

A suitable catalyst carrier with micropores that can be used in the present invention may include conductive solid powder, such as carbon powder, with microphores for incorporating catalytic metal particles therein. Examples of carbon powder include carbon black, Ketjen black, acetylene black, activated carbon powder, carbon nano-fiber power, and a mixture of the forgoing materials.

The ionomer forms an ionic transfer network in the interstices of the catalyst particles for smooth migration of protons and acts as a binder enabling the catalyst layer to retain proper mechanical strength. In the present invention, an ionomer with cation exchange groups enabling proton transfer is used. The cation exchange groups may be selected from the group consisting of a sulfonyl group, a carboxyl group, a phosphoric group, an imide group, a sulfonimide group, a sulfonamide group, and a hydroxy group.

Examples of ionomers with cation exchange groups include, but are not limited to, homopolymers and copolymers of trifluoroethylene, tetrafluoroethylene, styrene-divinyl benzene, α,β,β-trifluorostyrene, styrene, imide, sulfone, phosphazene, etherether ketone, ethylene oxide, polyphenylene sulfide, and an aromatic group, and derivatives thereof, which may be used alone or in combination.

Preferred examples of polymers with cation exchange groups include highly fluorinated polymer containing fluorine atoms that amount to at least 90% of the total number of fluorine and hydrogen atoms in the carbon backbone and side chains of the polymer.

Polymers with cation exchange groups may include highly fluorinated polymers having sulfonate groups as the cation exchange groups which contain fluorine atoms that amount to at least 90% of the total number of fluorine and hydrogen atoms in the carbon backbone and side chains of the polymer.

Any polymer with cation exchange groups, as disclosed in U.S. Pat. Nos. 3,282,875; 4,358,545; 4,940,525; and 5,422,411, is available in the present invention. For example, a homopolymer derived from a monomer having the formula of MSO₂CFR_{f}CF₂O[CFYCF₂O]ₙCF=CF₂ and a copolymer derived from the monomer and at least one monomer selected from the group consisting of ethylene, halogenated ethylene, perfluorinated α-olefin, and perfluoroalkylvinyl ether can be used. In the above formula, R_{f} is a radical selected from the group consisting of fluorine and C₁-C₁₀ perfluoroalkyl groups; Y is a radical selected from the group consisting of fluorine and a trifluoromethyl group; n is an integer from 1 to 3; M is a radical selected from the group consisting of fluorine, a hydroxy group, an amino group, and an —OMe group, where Me is a radical selected from the group consisting of alkali metal and a ternary ammonium group.

Another example of polymers with cation exchange groups includes a polymer with a substantially fluorinated carbon backbone and pendent groups having the formula of —O—[CFR′^{f}]_{b}[CFR_{f}]ₐSO₃Y, where a is an integer from 0 to 3; b is an integer from 0 to 3; a+b is no less than 1; R_{f} and R′^{f} are independently selected from the group consisting of halogen atoms and a substantially fluorinated alkyl group; and Y is hydrogen or alkaline metal.

Still another example of polymers with cation exchange groups includes a sulfonic fluoropolymer with a fluorinated carbon backbone and pendant groups having the formula of ZSO₂-[CF₂]a-[CFR_{f}]_{b}—O—, where Z is halogen, alkali metal, hydrogen, or —OR group; R is a C₁-C₁₀ alkyl or aryl radical; a is an integer from 0 to 2; b is an integer from 0 to 2; a+b is nonzero; and R_{f} is selected from the group consisting of F, Cl, a C₁-C₁₀ perfluoroalkyl group, and a C₁-C₁₀ fluorochloroalkyl group.

Polymers having the following formula can be used as ionomers with cation exchange groups:

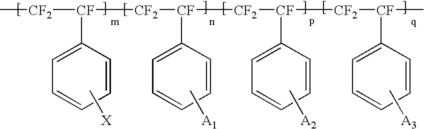

where m is an integer greater than zero; at least one of n, p, and q is an integer greater than zero; A₁, A₂, and A₃ are selected from the group consisting of an alkyl group, halogen atoms, C_{y}F_{2y+1} where y is an integer greater than zero, and an —OR group where R is an alkyl group, a perfluoroalkyl group, or an aryl group; CF is selected from the group consisting of CF₂, CN, NO₂, and OH; X is selected from the group consisting of SO₃H, PO₃H₂, CH₂PO₃H₂, COOH, OSO₃H, OPO₃H₂, OArSO₃H where Ar denotes an aromatic group, NR³⁺ where R is an alkyl group, a perfluoroalkyl group, or an aryl group, and CH₂NR³⁺ where R is an alkyl group, a perfluoroalkyl group, or an aryl group.

Examples of a solvent available for the above slurry include single and multi-component solvents capable of dissolving the catalytic metal precursor, dispersing the catalyst carrier, and dispersing or dissolving the ionomer. A preferred example of such a solvent is a mixture of water and organic solvent. Examples of an organic solvent include isopropyl alcohol (IPA), tetrabutyl acetate, n-butyl acetate, etc., which may be used alone or in combination.

According to an embodiment of the present invention, the slurry may be prepared as follows. A catalytic metal precursor solution containing a catalytic metal precursor and a first solvent capable of dissolving the catalytic metal precursor, and a catalyst carrier dispersion containing the ionomer and a second solvent capable of dispersing the ionomer and the catalyst carrier and miscible with the first solvent are prepared. Next, the catalytic metal precursor solution and the catalyst carrier dispersion are mixed together to provide a slurry for forming an unreduced catalyst layer. A preferred example of the first solvent is water capable of dissolving the catalytic metal precursor in chloride, nitrate, or sulfate form. More preferred examples of the first solvent include distilled water or deionized water. Examples of the second solvent include, but are not limited to, isopropyl alcohol (IPA), tetrabutyl acetate, N-butyl acetate, etc., which may be used alone or in combination.

In addition to the above method, there are various other methods of preparing a slurry for forming the unreduced catalyst layer within the spirit and scope of the present invention.

The amount of each of the components of the slurry is not limited. The amounts of catalytic metal precursor and catalyst barrier are determined based on a desired amount of catalyst to be loaded into a final electrode. The amount of ionomer is determined in consideration of the tradeoff between the electrochemical activity of the electrode and the formation of the ionic transfer network. The amount of solvent can be determined in consideration of solubility of the catalytic metal precursor, dispersion properties of the catalyst carrier, dispersion properties or solubility of the ionomer, and viscosity of the slurry desired for easy application. The amount of each of the components of the slurry can be determined by one of skill in the art in accordance with the desired nature of a target electrode.

The slurry is applied to a gas diffusion layer. Examples of the gas diffusion layer include, but are not limited to, carbon paper, and preferably, waterproofed carbon paper, and more preferably, waterproofed carbon paper or carbon cloth with a waterproofed carbon black layer.

The waterproofed carbon paper used for the gas diffusion layer contains about 5-50% by weight of a hydrophobic polymer, such as polytetrafluoroethylene (PTFE), which can be sintered. The use of waterproofed materials for the gas diffusion layer is for enabling both polar liquid reactants and gaseous reactants to pass through the gas diffusion layer.

In waterproofed carbon paper with a waterproofed carbon black layer, the waterproofed carbon black layer contains carbon black and about 20-50% by weight of a hydrophobic polymer, such as PTFE, as a binder. This waterproofed carbon black layer is attached to one surface of the waterproofed carbon paper described above. The hydrophobic polymer of the waterproofed carbon black layer is sintered.

The slurry is applied to one surface of the gas diffusion layer described above to form the unreduced catalyst layer. When the gas diffusion layer is formed of waterproofed carbon paper with a waterproofed carbon black layer, the slurry is applied to the waterproofed carbon black layer.

The slurry is applied to the gas diffusion layer by printing, spraying, painting, doctor blading, etc. The amount or the thickness of slurry applied is not limited and can be appropriately controlled depending on the composition of the slurry and the amount of catalyst loaded in a target electrode.

The unreduced catalyst layer formed on the gas diffusion layer is thermally treated in a reduction atmosphere. During this thermal treatment, the unreduced catalyst layer is reduced into an electrochemically active catalyst layer having catalytic metal particles converted from the catalytic metal precursor and embedded in the micropores thereof. As the solvent is evaporated, the catalyst layer is more solidified due to the binder ionomer. As a result, the formation of an electrically active electrode with the catalyst layer on the gas diffusion layer is completed.

The reduction atmosphere can be created by supplying hydrogen into a heating space of a heating apparatus, such as an oven or furnace.

If the thermal treatment temperature of the unreduced catalyst layer is too low, the catalytic metal precursor cannot be perfectly reduced. If the temperature is too high, the components of the unreacted catalyst layer are likely to be chemically modified. In view of this, it is preferable that the unreacted catalyst layer is treated at a temperature of, for example, about 150-350.

The duration of thermal treatment needs to be appropriately controlled. If the duration of thermal treatment is too short, the ratio of reduction of the catalytic metal precursor is too low. The reduction ratio of the catalytic metal is saturated and no longer increases after the unreduced catalyst layer is heated for a certain duration. In view of this, the thermal treatment is performed for, for example, about 0.5-5 hours.

In the electrode manufactured by the method according to the present invention described above, the catalyst layer contains catalytic metal particles uniformly distributed therein with good crystalline properties and an average particle diameter of 10 nm or less.

An electrode manufactured by the above method according to the present invention can be used as an anode or a cathode of a fuel cell which uses hydrogen or methanol as fuel and has a polymer electrolyte membrane. When a Pt precursor is used as the catalytic metal precursor, the resulting electrode is useful as a cathode of such a fuel cell. An electrode manufactured using a mixture of a Pt precursor and a Ru precursor is useful as an anode of such a fuel cell.

The present invention will be described in greater detail with reference to the following examples. The following examples are for illustrative purposes and are not intended to limit the scope of the invention.

### Example 1

### Manufacture of a Pt/C-catalyzed Electrode.

0.5 g of tetraamine platinum nitrate was dissolved in 10 mL of deionized water using an ultrasonicator to prepare a Pt precursor solution. 0.765 g of Ketjen black, corresponding to the amount capable of incorporating therein 30% by weight of the catalytic metal, was dispersed in 42 mL of isopropyl alcohol for 2 hours, 10.93 g of an ionomer solution (5% by weight of a Nafion solution, available from Dupont) was added into the solution, and the mixture was stirred for 1 hour to prepare a catalyst carrier dispersion. The Pt precursor solution and the catalyst carrier dispersion were mixed together with stirring to provide a slurry for an unreduced catalyst layer.

One surface of a carbon paper (Toray 090, available from Toray Co., Japan) containing about 20% by weight of PTFE was coated with a slurry prepared by mixing 1.6 g of an aqueous PTFE dispersion (about 50% by weight of PTFE), 1 g of carbon black (Vulcan XC 72R, available from Vulcan Co., U.S.A), and 50 g of isopropyl alcohol together. The carbon paper coated with the slurry was thermally treated at 350 in a nitrogen atmosphere for 30 minutes to sinter the PTFE. The amount of carbon black loaded was about 1.5 mg/cm². The resulting carbon paper having the carbon black layer, both of which were waterproof, was used as a gas diffusion layer.

The slurry for forming the unreduced catalyst layer was applied to the waterproof carbon black layer of the gas diffusion layer by spray coating and thermally treated in a tube furnace at about 200 under hydrogen atmosphere for about 1 hour.

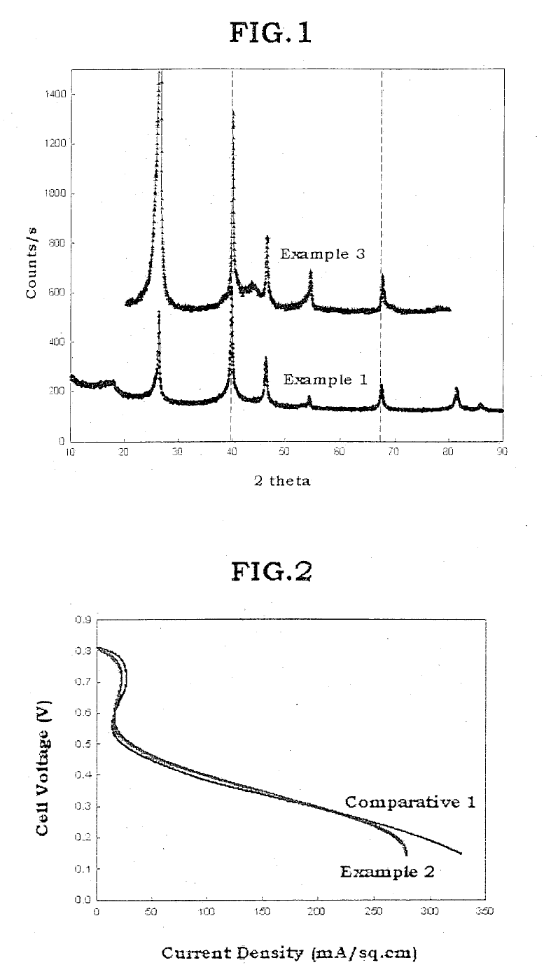

An X-ray diffraction analysis was performed on the resulting electrode having the Pt/C catalyst layer. The result is shown in FIG. 1. The result of FIG. 1 illustrates that Pt particles having good crystalline properties are incorporated in the catalyst layer of the electrode.

### Example 2

### Manufacture of a Direct Methanol Fuel Cell

The electrode manufactured in Example 1 was used as a cathode. Nafion 115 (a registered trademark of Dupont) was used as a polymer electrolyte membrane.

An anode doped with a Pt-Ru alloy in an amount of about 8 mg/cm² was manufactured using a commercially available catalyst. A gas diffusion layer for the anode was manufactured in the same manner as in Example 1. A slurry prepared by mixing 1.6 g of an aqueous PTFE dispersion (about 50% by weight of PTFE), 1 g of carbon black (Vulcan XC 72R, available from Vulcan Co., U.S.A), and 50 g of isopropyl alcohol together was applied to one surface of a carbon paper (Plain Toray 090, available from Toray Co., Japan) and thermally treated at 350 in a nitrogen atmosphere for 30 minutes. The amount of carbon black loaded was about 1.5 mg/cm².

The polymer electrolyte membrane was placed between the anode and the cathode and bound together by applying a pressure of about 5 ton at about 125 for about 3 minutes.

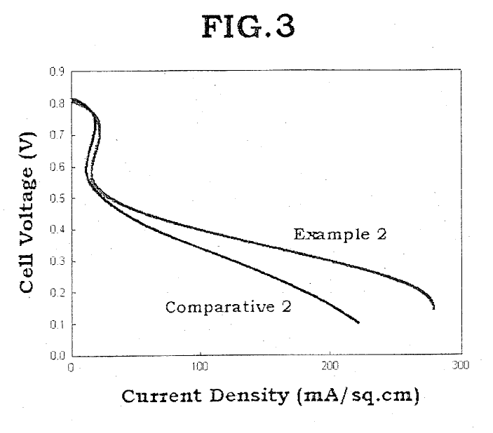

The performance of the resulting membrane electrode assembly (MEA) was measured at room temperature while supplying about 2M aqueous methanol solution to the anode and dry air to the cathode. Under these conditions, change in cell voltage with increasing current density was measured. The results are shown in FIGS. 2 and 3.

### Example 3

### Manufacture of a Pt-Ru/C-catalyzed Electrode

A solution of 0.482 g of tetraamine platinum nitrate dissolved in 10 mL of deionized water using an ultrasonicator and a solution of 0.385 g of ruthenium nitrosyl chloride hydrate dissolved in 10 mL of deionized water were mixed together to prepare a Pt-Ru precursor solution. 0.72 g of Ketjen black, corresponding to the amount capable of incorporating therein 30% by weight of the catalytic metal, was dispersed in 42 mL of isopropyl alcohol for 2 hours, 10.93 g of an ionomer solution (5% by weight of a Nafion solution, available from Dupont) was added into the solution, and the mixture was stirred for 1 hour to prepare a catalyst carrier dispersion. The Pt-Ru precursor solution and the catalyst carrier dispersion were mixed together with stirring to provide a slurry for an unreduced catalyst layer.

One surface of a carbon paper (Toray 090, available from Toray Co., Japan) containing about 20% by weight of PTFE was coated with a slurry prepared by mixing 1.6 g of an aqueous PTFE dispersion (about 50% by weight of PTFE), 1 g of carbon black (Vulcan XC 72R, available from Vulcan Co., U.S.A), and 50 g of isopropyl alcohol together. The carbon paper coated with the slurry was thermally treated at 350 in a nitrogen atmosphere for 30 minutes to sinter the PTFE. The amount of carbon black loaded was about 1.5 mg/cm². The resulting carbon paper having the carbon black layer, both of which were waterproof, was used as a gas diffusion layer.

The slurry for forming the unreduced catalyst layer was applied to the waterproof carbon black layer of the gas diffusion layer by spray coating and thermally treated in a tube furnace at about 200 under hydrogen atmosphere for about 1 hour.

An X-ray diffraction analysis was performed on the resulting electrode having the Pt-Ru/C catalyst layer. The result is shown in FIG. 1. The result of FIG. 1 illustrates that Pt-Ru alloy particles having good crystalline properties are incorporated in the catalyst layer of the electrode. The incorporation of Pt-Ru alloy particles in the electrode is proved by a Pt (111) peak or Pt (220) peak that is shifted to the right due to the presence of Ru particles in the Pt lattice. In other words, no separate peak for Ru appears [A. Arico, P. Creti, H. Kim, R. Mantegna, N. Giordarno, V. Antonucci, J. Power Sources, 55,1995,159]. For reference, peaks at 2θ=26.3, 41.2, 44.3, and 54.2 degrees in FIG. 1 are related to carbon.

### Comparative Example 1

### Manufacture of a Pt Black-catalyzed Electrode

1 g of commercially available Pt black (available from Johnson Matthey, Inc., U.S.A.), 0.12 g of Nafion (available from Dupont), and 15 g of isopropyl alcohol were mixed together to prepare a slurry for a catalyst layer. This slurry was applied to a gas diffusion layer manufactured in the same manner as in Example 1 and dried at about 80 to form a cathode. The amount of Pt loaded in the cathode was 3.0 mg/cm².

An MEA was manufactured in the same manner as in Example 2, except that the above cathode was used. A performance test was performed in the same manner as in Example 2. The result is shown in FIG. 2.

### Comparative Example 2

### Manufacture of an Electrode Using a Pt/C Catalyst Manufactured by Soaking

Ketjen black was soaked in a solution of hydrogenhexachloroplatinic acid in 5 mL of isopropyl alcohol and thermally treated at about 200 in a hydrogen atmosphere to attain a Pt/C catalyst.

1 g of the Pt/C catalyst, 0.5 g of Nafion (available from Dupont), and 50 g of isopropyl alcohol were mixed together to prepare a slurry for a catalyst layer. This slurry for a catalyst layer was applied to a gas diffusion layer manufactured in the same manner as in Example 1 and dried at about 80 to form a cathode. The amount of Pt loaded in the cathode was 2.8 mg/cm².

An MEA was formed in the same manner as in Example 2, except that the above cathode was used. A performance test was performed in the same manner as in Example 2. The result is shown in FIG. 3.

FIG. 2 is a graph comparatively showing performance of the fuel cell manufactured in Example 2 according to the present invention and the fuel cell manufactured in Comparative Example 1. The fuel cell of Example 2 and the fuel cell of Comparative Example 1 have the same polymer electrolyte membrane and the same anode. However, they have different cathodes; the fuel cell of Example 2 uses the cathode manufactured in Example 1, and the fuel cell of Comparative Example 1 uses the cathode manufactured using the commercially available catalyst. The amount of Pt loaded in the cathode was about 1.6 mg/cm² for the fuel cell of Example 2 and about 3 mg/cm² for the fuel cell of Comparative Example 1.

As shown in FIG. 2, despite the difference in the amount of Pt loaded, the performance is equal between the two fuel cells, indicating that the electrode manufactured using the method according to the present invention more efficiently utilizes the catalytic metal.

FIG. 3 is a graph comparatively showing performance of the fuel cell manufactured in Example 2 according to the present invention and the fuel cell manufactured in Comparative Example 2. The fuel cell of Example 2 and the fuel cell of Comparative Example 2 have the same polymer electrolyte membrane and the same anode. However, they have different cathodes; the fuel cell of Example 2 uses the cathode manufactured in Example 1, and the fuel cell of Comparative Example 2 uses the cathode containing the separately formed catalyst. The amount of Pt loaded in the cathode was about 1.6 mg/cm² for the fuel cell of Example 2 and about 2.8 mg/cm² for the fuel cell of Comparative Example 2.

Despite a much smaller amount of Pt loaded in the cathode of Example 2 than the cathode of Comparative Example 2, the fuel cell of Example 2 shows much greater performance than the fuel cell of Comparative Example 2, indicating that the electrode manufactured using the method according to the present invention has good electrochemical activity. In addition, since the catalyst layer is formed during the formation of the electrode, the electrode comprising the catalyst layer can be conveniently manufactured within a short time, without the need to separately form the catalyst layer. The simplified method for manufacturing an electrode for fuel cell according to the present invention takes a short time and is also advantageous in terms of manufacturing equipment requirements and costs. An electrode fuel cells with good electrochemical activity and improved catalytic efficiency can be manufactured with the method according to the present invention.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for manufacturing an electrode for fuel cells, the method comprising:
(a) applying a slurry containing a catalytic metal precursor, a catalyst carrier with micropores, an ionomer with cation exchange groups, and a solvent to a gas diffusion layer to form an unreduced catalyst layer; and
(b) thermally treating the unreduced catalyst layer in a reduction atmosphere to reduce the catalytic metal precursor to form a catalytic layer having catalytic metal particles embedded in the micropores of the catalyst carrier.

2. The method of claim 1, wherein the catalytic metal precursor is in a metallic salt form selected from the group consisting of chlorides, nitrates, sulfates of a catalytic metal, and a mixture of the forgoing materials.

3. The method of claim 1, wherein the catalytic metal precursor is a platinum precursor.

4. The method of claim 1, wherein the catalytic metal precursor is a mixture of a platinum precursor and a ruthenium precursor.

5. The method of claim 4, wherein the platinum precursor and the ruthenium precursor are mixed in a ratio such that the atomic mole ratio of platinum to ruthenium is 10:90-90:10.

6. The method of claim 1, wherein the catalyst carrier is carbon powder.

7. The method of claim 6, wherein the carbon powder includes carbon black, Ketjen black, acetylene black, activated carbon powder, carbon nano-fiber power, and a mixture of the forgoing materials.

8. The method of claim 1, wherein the solvent is a mixture of water and an organic solvent.

9. The method of claim 8, wherein the organic solvent includes isopropyl alcohol, tetrabutyl acetate, N-butyl acetate, and a mixture of the forgoing solvents.

10. The method of claim 1, further comprising:
dissolving the catalytic metal precursor in a first solvent to prepare a catalytic metal precursor solution;
dispersing the catalyst carrier with micropores and dissolving the ionomer with cation exchange groups in a second solvent to prepare a catalyst carrier dispersion; and
mixing the catalytic metal precursor solution and the catalyst carrier dispersion together to prepare the slurry.

11. The method of claim 10, wherein the first solvent is water.

12. The method of claim 10, wherein the second solvent includes isopropyl alcohol, tetrabutyl acetate, N-butyl acetate, and a mixture of the forgoing solvents.

13. The method of claim 1, wherein the gas diffusion layer is carbon paper.

14. The method of claim 1, wherein the gas diffusion layer is waterproofed carbon paper.

15. The method of claim 1, wherein the gas diffusion layer is waterproofed carbon paper with a waterproofed carbon black layer.

16. The method of claim 14, wherein the waterproofed carbon paper contains sintered polytetrafluoroethylene.

17. The method of claim 15, wherein the waterproofed carbon paper contains sintered polytetrafluoroethylene.

18. The method of claim 1, wherein, in step (b), the unreduced catalyst layer is thermally treated at a temperature of 150-350.

19. The method of claim 1, wherein, in step (b), the unreduced catalyst layer is thermally treated for a duration of 0.5-5 hours.
